(19) United States
(12) Patent Application Publication
(10) Pub. No.: US 2025/0378373 A1
(43) Pub. Date: Dec. 11, 2025

(54) ENTITY AWARE SUMMARIZATION USING DIRECTIONAL STIMULUS PROMPTING

(71) Applicant: Oracle International Corporation, Redwood Shores, CA (US)

(72) Inventors: Suman Roy, Bangalore (IN); Sriram Chaudhury, Bangalore (IN); Shikha Singhal, Faridabad (IN)

(73) Assignee: Oracle International Corporation, Redwood Shores, CA (US)

(21) Appl. No.: 18/740,185

(22) Filed: Jun. 11, 2024

(51) Int. Cl. G06N 20/00

(52) U.S. Cl. CPC G06N 20/00

(57) ABSTRACT

A summarization system (SS) is described that uses novel techniques to generate entity-aware summaries, where the novel techniques employ directional stimulus prompting and a large language model (LLM) to generate the summaries. In some embodiments, the SS receives as input the content to be summarized and a set of one or more entity categories corresponding to entities to be included in the generated summary. Hint information is generated based upon the content to be summarized. A prompt comprising the generated hint information and the content to be summarized is provided as input to a black-box LLM to generate an entity-aware summary. Novel techniques, including supervised fine-tuning and reinforcement learning are also described for training a language model generating the hint information.

### FIELD

The present disclosure generally relates to the generation of summaries using machine learning (ML) techniques. More specifically, a summarization system (SS) that uses novel techniques to generate entity-aware summaries is described, where the novel techniques employ directional stimulus prompting and a large language model (LLM) to generate the summaries.

### BACKGROUND

In today's information-rich age, the volume of data that is generated is extremely large. The success or failure of a user (e.g., a human user, a company, etc.) of that data often depends on their ability to comprehend the data quickly. In many use cases, given the timeframe available for comprehending the data, it is impossible for the user to read or review all the original data. Instead, the user has to rely on a summary of the data. Summarization is a process that generates a summary for some data, where the length or size of the summary is far less than that of the original data being summarized. A summary is typically a shortened or condensed version of much larger data content that retains the main themes, concepts, or ideas described in the larger content. A good summary is one that properly and accurately represents the content being summarized.

Summarization is an important task in various use cases, for example, as part of Natural Language Processing. Abstractive summarization is also closely related to data compression and information understanding, both of which are key to information science and retrieval. Being able to produce informative and well-written document summaries has the potential to greatly improve information discovery systems and help human readers who are trying to skim large numbers of documents for important quickly.

In the past, summaries were manually generated. This took a lot of effort and time. With the rise of artificial intelligence (AI) and machine learning (ML) techniques, and particularly with the rising popularity of Large Language Models (LLMs), LLMs are used to generate summaries for various types of content, such as documents, webpages, news articles, research papers, etc. This has made it substantially easier to generate summaries in a very short time. For example, a GPT-3 LLM, along with zero-or few-shot prompting, can be used to generate summaries. However, the quality of these LLM-generated summaries is still not as good as desired.

### BRIEF SUMMARY

The present disclosure generally relates to the generation of summaries using machine learning (ML) techniques. More specifically, a summarization system (SS) is described that uses novel techniques to generate entity-aware summaries, where the novel techniques employ directional stimulus prompting and a large language model (LLM) to generate the summaries.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

Various techniques are provided for enabling the summarization system (SS) to use directional stimulus prompting and a large language model (LLM) to generate entity-aware summaries. In one general aspect, the techniques may include a method. The method includes receiving, by a summarization system (SS) comprising one or more computer systems, content to be summarized. The method may also include generating, by the SS, a hint based upon the content to be summarized, the hint comprising one or more entities identified by the SS from the content to be summarized, the one or more entities corresponding to one or more entity categories, where each entity in the one or more entities is a word occurring in the content to be summarized or a sequence of adjacent words occurring in the content to be summarized. The method may also include generating, by the SS, a prompt comprising the content to be summarized and the hint. The method may also include providing, by the SS, the prompt as input to a large language model (LLM). The method may also include responsive to the prompt, generating, by the LLM, a summary for the content to be summarized.

In various embodiments, a system is provided that includes one or more data processors and a non-transitory computer readable medium containing instructions which, when executed on the one or more data processors, cause the one or more data processors to perform part or all of one or more methods disclosed herein.

In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer program/instructions which, when executed by a processor, cause the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment 100 illustrating a trained summarization system (SS), according to certain embodiments.

FIG. 2 is a simplified block diagram of the distributed environment 200 illustrating the trained summarization system (SS) in FIG. 1 with additional contextual training at run-time, according to certain embodiments.

FIG. 3 is an example flowchart illustrating processing performed by a summarization system (SS), according to certain embodiments.

FIG. 4 is a simplified block diagram of a training environment 400 that may be used to train a policy language model (PLM) within the SS, according to certain embodiments.

FIG. 5 is a simplified block diagram of a training environment 500 that may be used to train a policy language model (PLM) within the SS, according to certain embodiments.

FIG. 6 is an example flowchart illustrating a generalized method for training a summarization system (SS), according to certain embodiments.

FIG. 7 is an example flowchart illustrating a method (e.g., SFT) for training a policy language model (PLM) within the SS, according to certain embodiments.

FIG. 8 is an example flowchart illustrating a method (e.g., RL) for training a policy language model (PLM) within the SS, according to certain embodiments.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure generally relates to the generation of summaries using machine learning (ML) techniques. More specifically, a summarization system (SS) is described that uses novel techniques to generate entity-aware summaries, where the novel techniques employ directional stimulus prompting and a large language model (LLM) to generate the summaries. These summaries are enriched with information for entities corresponding to certain entity categories.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

As indicated in the Background section, summarization is an important task and LLMs like GPT-3 are used to generate such summaries. However, the quality of these LLM-generated summaries is still not as good as desired. For example, a client (e.g., a user of a summary, or entity responsible for generating a summary) may desire a high-quality summary to be generated using an LLM that includes certain entities (e.g., words) appearing in the original content to be summarized and where the entities correspond to certain entity categories that are relevant to the client. For example, a hospital may use an LLM to generate summaries of discharge notes for patients. For a patient, the hospital may desire that the summary generated for the patient's hospital discharge note, include the patient's name, the doctor's name, the patient's address, medicines prescribed to the patient, etc. Current LLM-based summary generation solutions do not provide this functionality.

Conventional techniques of using LLMs to generate summaries also suffer from other limitations. Using an out-of-the-box (or black box) LLM to generate summaries results in low-quality summaries, especially when the summaries are to be generated for specific domains or use cases. Typically, in such a scenario, a pretrained LLM (e.g., GPT-3) is further trained using training data for the particular use case or domain for which summaries are to be generated. However, training an LLM is a technically challenging task and requires a large amount of processing resources. Very few users (e.g., human users, entities, companies) can do this.

The present disclosure describes a novel summarization system (SS) capable of generating high-quality entity-aware summaries. The summarization system uses novel techniques to generate entity-aware summaries, where the novel techniques use directional stimulus prompting in conjunction with a large language model (LLM) to generate the entity-aware summaries. In certain implementations, an entity-aware summary is generated using a black-box LLM (BB-LLM) that does not need to be further trained.

In certain embodiments, the SS receives as input the content to be summarized and a set of one or more entity categories corresponding to entities to be included in the generated summary. The entity categories identify types of entities that are relevant to the summarization process. Examples of entity categories include a person, a location, etc. In the hospital discharge notes use case, the entity categories may be patient name, medicines, doctor name, patient address, etc.

The SS is then configured to extract a set of entities corresponding to the entity categories from the input content to be summarized. For purposes of this disclosure, an entity is a word or a sequence of adjacent words occurring in the content to be summarized. An entity corresponds to an entity category. For example, if “city” is identified as an entity category, then words such as “Paris” or “Mumbai” or a sequence of words such as “San Francisco” or “Buenos Aires” occurring in the content to be summarized are extracted as entities.

In certain implementations, the collection of entities extracted from the content to be summarized represents hint information (or simply hint) or stimulus information (or simply stimulus). The SS generates a prompt using the content to be summarized and the hint (or stimulus). The generated prompt is then provided as an input prompt to a BB-LLM that is part of the BB-LLM. The BB-LLM then generates a summary responsive to the prompt. Since the prompt includes the content to be summarized and the set of entities, corresponding to the entity categories, extracted from the content to be summarized, the resultant summary generated by the

BB-LLM uses the extracted entities to guide the summary generation. The generated summary is thus an entity-aware summary of the content to be summarized.

In certain implementations, the generated entity-aware summary is such that each entity extracted from the content to be summarized, and corresponding to an entity category, appears at least once in the generated summary. For example, if entity categories EC1, EC2, and EC3 are input to the SS, and further assuming that the following entities are extracted or identified in the content to be summarized by the SS:
Entity 1, Entity2—corresponding to EC1
Entity3—corresponding to EC2
Entity 4, Entity5—corresponding to EC3, then

Then, the summary generated by the BB-LLM includes at least one instance of Entity1, Entity2, Entity3, Entity4, and Entity5. In this manner, the generated entity is an entity-aware summary, and the summary generation process is guided by the extracted entities Entity 1, Entity2, Entity3, Entity4, and Entity5.

The SS may use different techniques to extract the entities or hint information from the content to be summarized, generate the prompt, and input the prompt to the BB-LLM. In certain implementations, the SS uses a machine learning model to extract the entities corresponding to the input entity categories from the content to be summarized. This model is referred to as a policy language model (PLM). Examples of models that can be used as a PLM include a language model (e.g., BERT), a model trained to perform entity extraction, an LLM (e.g., GPT-3), and others.

In certain implementations, a model that has been pre-trained to perform entity extraction given a set of entity categories may be used as the PLM. In other embodiments, a pre-trained model may be further trained to perform the entity extraction. Different training techniques may be used based on the type of PLM model used. For example, if an LLM is used as a PLM, the zero-shot, one-shot, or multiple-shot contextual prompting techniques may be used to fine-tune the PLM, and the PLM then extracts the entities corresponding to the entity categories from the content to be summarized, and outputs a hint that includes the extracted entities.

As another example, if a model such as BERT is used, then supervised fine-tuning (SFT) techniques may be used for training the PLM. In this scenario, a training dataset comprising multiple training datapoints may be used to train and tune the PLM. During the training phase, for a training datapoint, the hint output by the PLM for content to be summarized in the training datapoint may be compared to the ground truth hint for the training datapoint. A loss function may be used to calculate a loss. Using backward propagation techniques, loss minimization may then be performed to minimize the loss, and the PLM model parameters may be updated accordingly.

In yet other embodiments, in addition to the SFT training, reinforcement learning (RL) techniques may be used for training a PLM. For a training datapoint in a training dataset, as part of the training phase, the PLM may generate a hint corresponding to the content to be summarized in the training datapoint, where the hint include a set of one or more entities extracted by the PLM corresponding to the entity categories input to the PLM. The SS then generates a prompt that includes the content to be summarized and the PLM-generated hint. The prompt is provided as input to the BB-LLM, which generates a summary responsive to the prompt. A score is calculated based upon the BB-LLM-generated summary and the ground truth summary for the training datapoint. RL training techniques are then used to update the parameters of the PLM model based on the calculated score. In this manner, both SFT and RL training techniques may be used to train the PLM. Once sufficiently trained, the PLM can be used by the SS for runtime generation of summaries.

In certain implementations, a unique and new scoring function is used to calculate the score to facilitate the RL training. In certain implementations, the scoring function uses a combination of a ROUGE score and a new ROUGE-SAL score to calculate the score used for the RL training of the PLM. The scoring function is used to calculate a combined score. A reward is then determined based on the combined score. The reward is then used to update the model parameters of the PLM. For example, PLM is a type of neural network, so updating the model parameters can include changing the weights associated with the nodes in the neural network. In some embodiments, the SFT and RL techniques may be performed concurrently to train the PLM. Once sufficiently trained, the PLM can then be used by the SS for runtime generation of summaries.

A novel summarization system (SS) is described as one that generates an entity-aware summary, where one or more entity categories are used to guide the generation of the summary. In certain implementations, the summarization system (SS) comprises a policy language model (PLM) trained to extract entities from the content to be summarized corresponding to the entity categories, and output the extracted entities as a hint or stimulus. The SS further includes a prompt generator that generates a prompt that includes the hint and the content to be summarized. The generated prompt is provided as input to a BB-LLM, which generates an entity-aware summary for the content to be summarized.

The summarization system (SS) described in this disclosure provides advancements and improvements over existing approaches. A new architecture is provided for generating an entity-aware summary comprising a PLM and a BB-LLM. The SS automatically generates a prompt, where the prompt includes a hint that includes a set of entities extracted by the PLM. The prompt is provided as input to BB-LLM, which then generates the entity-aware summary.

Novel training techniques are described for training or fine-tuning components of the SS, such as the PLM. When an LLM is used as the PLM, the LLM may be fine-tuned using prompting techniques such as zero-shot, or few-shots techniques during runtime processing. For some models, a combination of SFT and RL training techniques may be used for training the PLM. The combination of the training techniques further enhances the performance of the PLM, while directly optimizing the entity-aware summary generated by the BB-LLM As part of the RL training, a new scoring technique is used for the RL training.

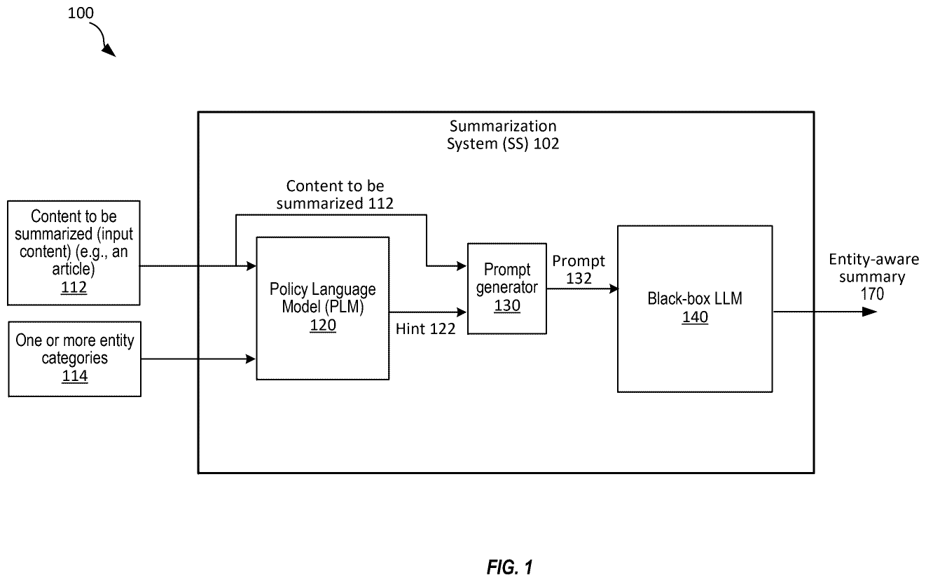

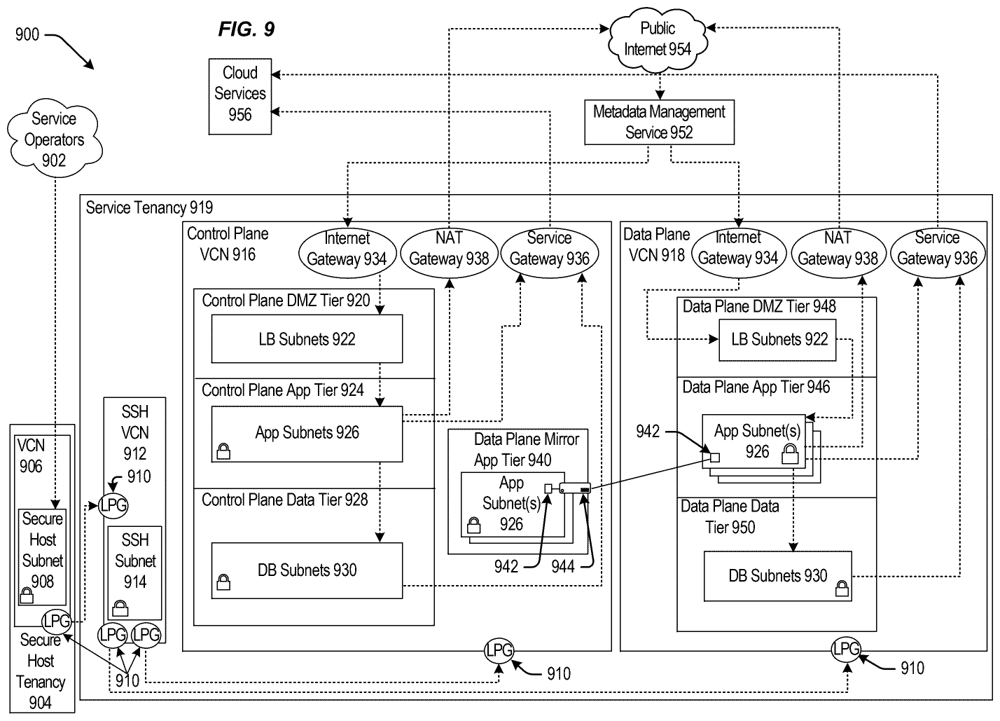

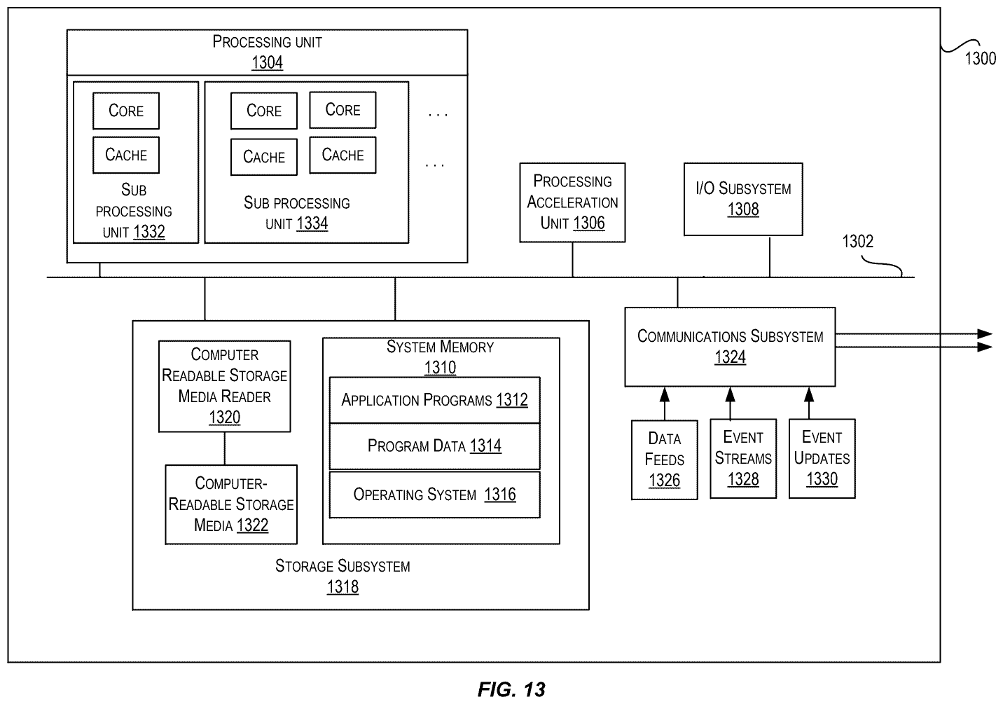

FIGS. 1-8 and the associated description describe examples and embodiments related to the entity-aware summarization using directional stimulus prompting described in this disclosure. FIGS. 9-12 depict examples of architectures for implementing cloud infrastructures for providing one or more cloud services, where the infrastructures may incorporate teachings described herein. FIG. 13 depicts a block diagram illustrating an example computer system or device, according to at least one embodiment.

FIG. 1 is a simplified block diagram of a distributed environment 100 illustrating a trained summarization system (SS), according to certain embodiments. Distributed environment 100 depicted in FIG. 1 is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

The SS depicted in FIG. 1 may be implemented in different ways. In certain implementations, one or more computer systems may be used to implement the SS. In some implementations, the functionality provided by the SS may be offered as a cloud service by a cloud services provider (CSP). The cloud service may be made available to customers of the CSP that subscribe to the service. In such a cloud-based embodiment, the SS may be implemented using infrastructure (e.g., compute, memory, and networking infrastructure) provided by the CSP.

As shown in FIG. 1, a SS 102 may include pre-trained policy language model (PLM) 120, a prompt generator 130, and a black-box LLM (BB-LLM) 140. The SS may be capable of generating entity-aware summaries 170 at run time based on input content to be summarized 112 and a set of one or more entity categories 114 provided by a client (e.g., a user of a summary, or entity responsible for generating a summary).

Content to be summarized 112 refers to text in a document, images converted by optical character recognition (OCR), texts entered by the client through a user-interface device, etc. The set of one or more entity categories may identify types of entities that are relevant to the summarization process. An entity is a word or a sequence of words occurring in the content to be summarized. For example, a single word, such as “Paris” or “Mumbai,” and a sequence of words, such as “San Francisco” or “Buenos Aires,” may correspond to the entity type “city.” As another example, entities, such as “France” or “U.S.A.,” may correspond to entity type “country.” A token is a single unit of text, which can be a word, a subword, a punctuation mark, a number, or a symbol. For example, the phrase “Paris is a capital.” may include several tokens: “Paris,” “is,” “a,” “capi,” “tal,” “,” and “”. An entity may be considered as an ordered sequence of tokens.

In FIG. 1, the PLM 120 may be a machine learning model that has been trained to perform entity extraction given a set of entity categories to output the extracted entities as a hint 122 (or referred to as directional stimulus). Examples of models that can be used as a PLM include a language model (e.g., bidirectional encoder representations from transformers (BERT)), a model trained to perform entity extraction, an LLM (e.g., generative pre-trained transformer (GPT-3 or GPT-4)), and others. Continuing with the example, suppose the content to be summarized includes the following texts:
“Paris is the capital of France. It has the maximum population among all cities in France with an estimated 2,175,601 people living in the city which covers an area of more than 105 sq kilometers. The city of Paris is the center and seat of government in the region, and it is a province of Ile-de-France.”

Further, assume that the one or more entity categories provided by the client include city, country, population, and state. The PLM may perform entity extraction to output a hint containing the following entities, corresponding to entity categories (in parentheses): “Paris” (city); “capital” (city); “France” (country); “2,175,601 people” (population); and “Ile-de-France” (state).

In some embodiments, the hint 122 and the content to be summarized 112 may be used by a prompt generator 130 to generate a prompt 132 as input to a BB-LLM 140. The BB-LLM can generate entity-aware summary 170 for the content to be summarized using the hint containing the extracted entities as a guide. Continuing with the above example, the guided entity-aware summary 170 outputted by the BB-LLM may be the following:
Paris (City) is the capital (City) and most populous city of France (Country). Paris has an estimated 2,175,601 people (Population). Paris is a province of Ile-de-France (State).

As shown above, the entity-aware summary include the extracted entities (e.g., “Paris,” “capital,” “France,” “2,175,601 people,” and “Ile-de-France”) corresponding to entity categories (in parentheses) provided by the client. Although the one or more entity categories (e.g., “city,” “country,” “population,” and “state”) 114 provided by the client are not in the content to be summarized 112, the SS 102 can generate entity-aware summary with entities corresponding to the provided entity categories.

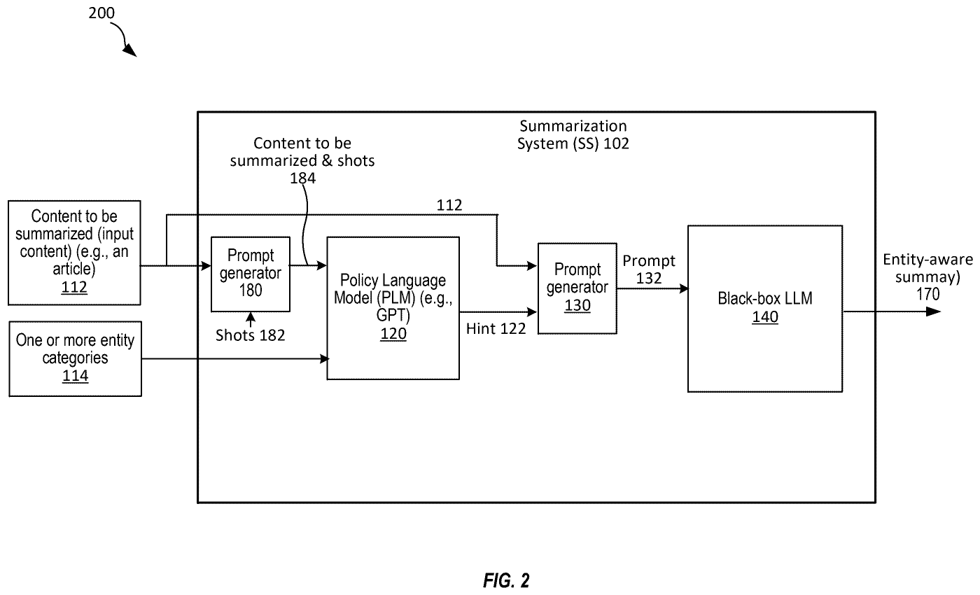

FIG. 2 is a simplified block diagram of the distributed environment 200 illustrating the

trained summarization system (SS) in FIG. 2 with additional contextual training at run-time, according to certain embodiments. Distributed environment 100 depicted in FIG. 2 is merely an example and is not intended to unduly limit the scope of claimed embodiments. Many variations, alternatives, and modifications are possible. For example, in some implementations, distributed environment 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

FIG. 2 illustrates another embodiment of a trained summarization system (SS). Similar to FIG. 1, FIG. 2 may have a pre-trained PLM. However, the PLM may be further trained to perform the entity extraction if an LLM (e.g., GPT) is used as a PLM. In such embodiments, the zero-shot, one-shot, or multiple-shot (e.g., 182) contextual prompting techniques may be used to fine-tune the PLM, and the PLM then extracts the entities corresponding to the entity categories from the content to be summarized and outputs a hint that includes the extracted entities.

For example, an additional prompt generator 180 may be added for contextual prompting by providing shots 182 as input to the additional prompt generator 180. Contextual prompting may be a technique to guide the PLM to perform specific tasks by providing a small number of examples or “shots.” The examples can serve as a context or a template to help the PLM understand the reasoning or desired output format for the specific tasks. As an illustration, the multiple-shot can have one or two examples, such as the following:
Input: “Please identify the city category in the following text: ”
Prompt template: New York is on the east coast of the U.S. “New York” belongs to the city category.

Based on the example, which includes an entity (e.g., “New York”) and its corresponding entity category (“city”), provided to the PLM, the PLM can be fine-tuned to perform entity extraction for the entity category “city.” The contextual prompting may fine-tune the PLM to perform entity extraction for different geographic regions, as illustrated by the above example, or other types of entity categories (e.g., literature, science, etc.).

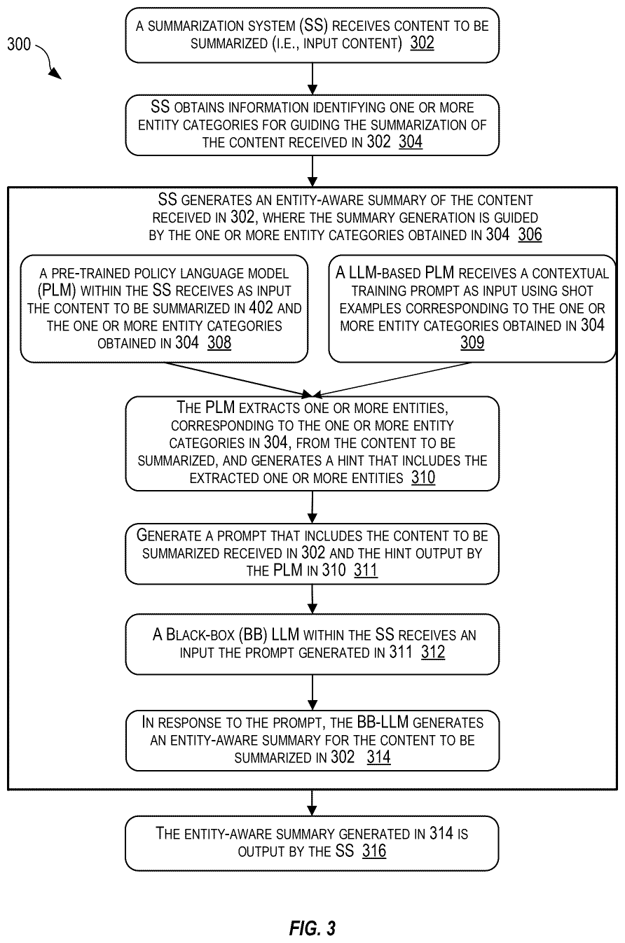

FIG. 3 is an example flowchart illustrating processing performed by a summarization system (SS), according to certain embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 3 may include a greater number or a lesser number of steps than those depicted in FIG. 3.

At 302, a summarization system (SS) receives content to be summarized (i.e., input content). For example, in FIG. 1, the SS 102 receives content to be summarized 112, such as an article in texts (e.g., “Paris is the capital of France, and has maximum population among all cities in France.”).

At 304, SS obtains information by identifying one or more entity categories to guide the summarization of the content received in 102. For example, in FIG. 1, the SS 102 may obtain a set of one or more entity categories 114 (e.g., city and country) from a client to guide the summarization of the content to be summarized 112.

At 306, which includes sub-steps 308 to 314, SS generates an entity-aware summary of the content received in 302, where the summary generation is guided by the one or more entity categories obtained in 304. 306 may be performed in two ways, starting with either 308 for a pre-trained PLM or 309 for fine-tuning a pre-trained PLM.

In one way, at 308, a pre-trained policy language model (PLM) within the SS receives as input the content to be summarized in 402 and the one or more entity categories obtained in 304. For example, in FIG. 1, the content to be summarized 112 and set of one or more entity categories 114 are provided directly as input to the PLM 120, which is configured to extract the entities corresponding to the one or more entity categories.

Alternatively, 309, an LLM-based PLM may receive a contextual training prompt as input using shot examples corresponding to the one or more entity categories obtained in 304. For example, as discussed above in relation to FIG. 2, prompt generator 180 may receive the content to be summarized 112 as input and create a prompt 184 based on the content 112 and some shot examples pertaining to those entity categories. The prompt 184 is then provided to the PLM 120 in addition to the set of one or more entity categories 114. The PLM then performs entity extraction. In other words, when an LLM is used as a PLM, contextual training and prompting can be used to facilitate the extraction of these entities.

Both 308 and 309 may proceed to 310. At 310, the PLM extracts one or more entities, corresponding to the one or more entity categories in 304, from the content to be summarized and generates a hint that includes the extracted one or more entities. For example, in FIG. 1, PLM 120 may perform entity extraction to output a hint 122 containing the entities (e.g., Paris and France), corresponding to the one or more entity categories 114 (e.g., city and country), and extracted from the content to be summarized 112.

At 311, a prompt that includes the content to be summarized is received in 302, and the hint output by the PLM in 310 is generated. For example, in FIG. 1, a prompt generator 130 may receive the content to be summarized 112 and the hint (or directional stimulus) 122 outputted by the PLM, and then generate a prompt 132.

At 312, a black-box (BB) LLM within the SS receives an input from the prompt generated in 311. For example, in FIG. 1, the prompt 132 generated by the prompt generator 130 is provided as input to the BB-LLM 140.

At 314, in response to the prompt, the BB-LLM generates an entity-aware summary for the content to be summarized in 302. For example, in FIG. 1, the BB-LLM 140 may generate an entity-aware summary 170 (e.g., Paris is the capital and most populous city of France.”) for the content to be summarized 112 provided as input to the SS 102 and guided by the one or more entity categories 114 ((e.g., city and country).

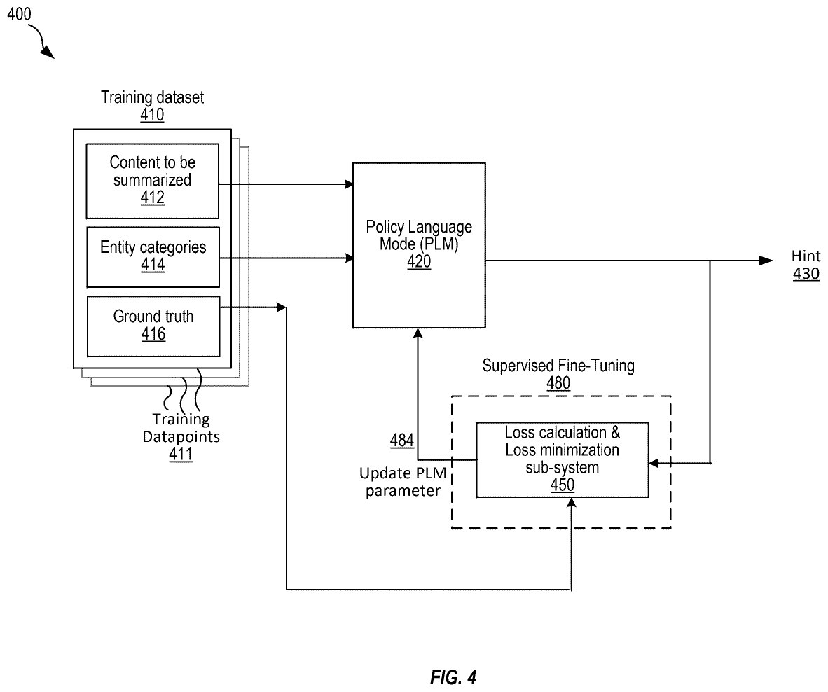

FIG. 4 is a simplified block diagram of a training environment 400 that may be used to train a policy language model (PLM) within the SS, according to certain embodiments. The training environment 400 depicted in FIG. 4 is merely an example and is not intended to unduly limit the scope of claimed embodiments. Many variations, alternatives, and modifications are possible. For example, in some implementations, training environment 400 may have more or fewer systems or components than those shown in FIG. 4, may combine two or more systems, or may have a different configuration or arrangement of systems. The systems, subsystems, and other components depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In certain embodiments, if a machine learning model such as Bidirectional Encoder Representations from Transformers (BERT) is used as a PLM, supervised fine-tuning (SFT) techniques 480 may be used for training the PLM to perform entity extraction based on entity categories provided by a client.

As shown in FIG. 4, a training dataset 410 comprising multiple training datapoints may be used to train a PLM 420. Each training datapoint 411 may include content to be summarized 412 (also referred to as training content to be summarized), entity categories 414 (also referred to as training entity categories), and ground truth 416 (e.g., hint). The content to be summarized 412 and entity categories 414 are provided as input to the PLM 420 to generate hint 430. The hint may include the entities corresponding to the entity categories 414 and extracted from the content to be summarized 412.

The ground truth 416 is provided as an input to a loss calculation & loss minimization sub-system 450 performing supervised fine-tuning. The loss calculation computes the discrepancy between the model's prediction (e.g., the generated hint or predicted hint 430) and the ground truth hint 416. The loss minimization aims to adjust the model's parameters (e.g., weights and biases) to minimize the computed loss. In some embodiments, the loss calculation and the loss minimization may be two separate modules (e.g., loss function/calculation and loss minimization) in the sub-system 450.

Similar to the discussion in FIG. 1, the content to be summarized 412 may be text in a document, images converted by optical character recognition (OCR), texts entered by the client through a user-interface device, etc. The entity categories 414 may identify types of entities that are relevant for the summarization process. The ground truth 416 may identify entities (i.e., ground truth hint) that are expected to be extracted from the content to be summarized 412 and correspond to the entity categories 414 in the training datapoint.

For example, the content to be summarized 412 for a datapoint may include the following texts:
“Paris is the capital of France. It has the maximum population among all cities in France with an estimated of over 2 million people living in the city. The city of Paris is the center and seat of government in the region and a province of Ile-de-France.”

The entity categories 414 of the datapoint may include city, country, population, and state. The ground truth hint 416 for the datapoint may include “Paris” (for city); “capital” (for city); “France” (for country); “2 million people” (for population); and “Ile-de-France” (for state).

During the training phase, for a training datapoint, the hint 430 output by the PLM for content to be summarized 412 in the training datapoint may be compared to the ground truth hint 416 for the training datapoint. A loss function of sub-system 450 may be used to calculate a loss to evaluate how well the PLM has been trained. In certain embodiments, backward propagation techniques may be used to minimize the loss. As part of backpropagation processing, with each training iteration, the trainable parameters (e.g., weights) associated with the PLM may be updated (e.g., via 484) to minimize the loss and improve performance. In some embodiments, the trainable parameters may include, but are not limited to, weights and biases within the PLM. The process of fine-tuning or updating trainable parameters continues until the loss minimization sub-system 450 finds a set of model parameters that minimize the loss to within desired limits.

For example, during the first training iteration, PLM generates a hint containing only “Paris” and “France.” After the backward propagation to minimize the loss, the model parameters of PLM are updated. During the second training iteration, PLM generates a hint containing “Paris,” “France,” and “Ile-de-France.” The training process may continue until the loss is within a desired limit, for example, at least one entity for each category: “Paris,” “France,” “2 million people,” and “Ile-de-France.”

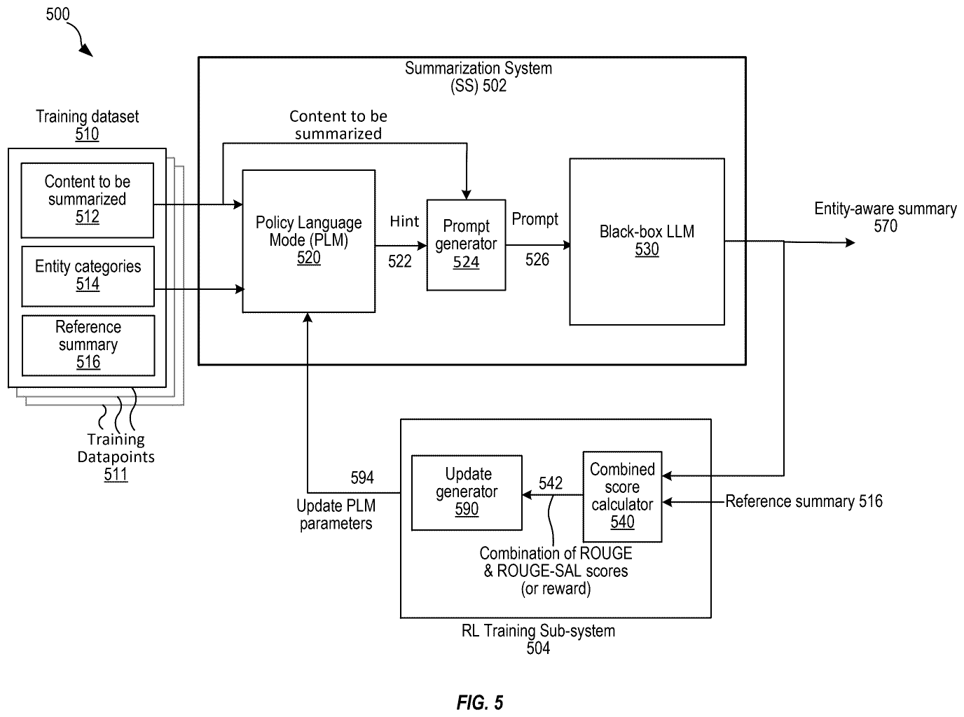

FIG. 5 is a simplified block diagram of a training environment 500 that may be used to train a policy language model (PLM) within the SS, according to certain embodiments. Various different training techniques may be used to train PLM 520. As shown in FIG. 4 and described above, a supervised training technique may be used to train the PLM. In certain implementations, as shown in FIG. 5, in addition to the supervised training or instead of the supervised training, a reinforcement learning (RL) technique is used to train PLM 520.

The SS depicted in FIG. 5 may be implemented in many ways. In certain implementations, one or more computer systems may be used to implement the SS. In some implementations, the functionality provided by the SS may be offered as a cloud service by a cloud services provider (CSP). The cloud service may be made available to customers of the CSP that subscribe to the service. In such a cloud-based embodiment, the SS may be implemented using infrastructure (e.g., compute, memory, and networking infrastructure) provided by the CSP

The training environment 500 depicted in FIG. 5 is merely an example and is not intended to unduly limit the scope of claimed embodiments. Many variations, alternatives, and modifications are possible. For example, in some implementations, training environment 500 may have more or fewer systems or components than those shown in FIG. 5, may combine two or more systems, or may have a different configuration or arrangement of systems. The systems, subsystems, and other components depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As shown in FIG. 5, reinforcement learning (RL) techniques may be used for training a PLM while directly optimizing the BB-LLM generated summary. As shown in FIG. 5, a RL training sub-system 504 is responsible for training PLM 520 using one or more RL training techniques. In the embodiment depicted in FIG. 5, RL training subsystem 504 comprises a combined score calculator 540 and an update generator 590.

A training dataset 510 is used to train PLM 520. Training dataset 510 comprises multiple training datapoints. In certain implementations, each training datapoint in the training dataset 510 includes content to be summarized 512 (also referred to as training content to be summarized), one or more entity categories 514 (also referred to as training entity categories), and a reference summary 516. For a training datapoint, the reference summary 516 included in that training datapoint is an entity-aware summary of the content to be summarized in that training datapoint, where the entity-aware summary includes one or more entities present in the content to be summarized and where the one or more entities correspond to the one or more categories identified in the training datapoint.

For a training datapoint, the content to be summarized 512 included in that datapoint may include text content comprising one or more words. For example, the text may be in the form of a document. In some other use cases, the text content may be text generated from applying optical character recognition (OCR) techniques to an image, etc. The one or more entity categories 514 in a training datapoint may identify categories (e.g., City, Country) that are relevant to the user of the SS for which the PLM is to be trained.

As part of the training phase, each of the training datapoints 510 is provided as input to the PLM 520 that is to be trained. In response to receiving a training datapoint as input, the PLM 520 generates a hint 522, where the hint 522 includes a set of one or more entities extracted by the PLM 520 from the content to be summarized in the training datapoint and where the extracted entities correspond to the one or more entity categories 514 in the training datapoint that is input to the PLM 520.

As shown in FIG. 5, the hint 522 generated by the PLM 520 and the content to be summarized 512 for the training datapoint is then provided as input to prompt generator 524, which generates a prompt 526 that includes the hint 522 and the content to be summarized 512 for the training datapoint. Prompt 526 is then provided (as input) to the BB-LLM 530. Responsive to the prompt 526, BB-LLM 530 generates an entity-aware summary 570 for content to be summarized in the training datapoint.

The entity-aware summary 570 generated by the BB-LLM 530 for the training datapoint is then provided to RL training subsystem 504 for evaluation. Along with the entity-aware summary 570 generated by the BB-LLM 530 for the training datapoint, the RL training sub-system 504 also receives as input the reference entity-aware summary 516 included in that training datapoint. RL training subsystem 504 then applies an RL training technique, and based upon the summary 570 and the reference summary 516 determines updates to be made to PLM 520 and cause those updates to be made to PLM 520.

In some embodiments, the RL training sub-system 504 uses a novel scoring function to facilitate the RL training. In certain embodiments, the scoring function is articulated as a combination of (1) a Recall-Oriented Understudy for Gisting Evaluation (ROUGE) score and (2) a ROUGE with saliency (ROUGE-SAL) score. The scoring function is used to calculate a combined score that is based on the ROUGE and ROUGE-SAL scores. The score function is thus also referred to as the combined scoring function, and the score computed using the function is referred to as the combined score. The combined score is then used by RL training subsystem 504 to determine a reward, and the reward is then used to determine how to update the parameters of PLM 520. In some embodiments, the combined score may be used as the reward.

In certain implementations, RL training subsystem 504 includes multiple subcomponents or subsystems, which working cooperatively, perform the functions performed by RL training subsystem 504. For example, in the embodiment depicted in FIG. 5, RL training subsystem 504 includes a combined score calculator subsystem 540 and a model updater subsystem 590. Subsystems 540 and 590 may be implemented only in software (which may be executed by one or more processors), only in hardware, or combinations thereof.

An example of a scoring function (or combined score calculator) that may be used by RL training subsystem 504 as part of the RL training to calculate the combined score is shown below:

$${R}_{\{ LLM \}} ( x , z ) = λ R ( x , y ) + ( 1 - λ ) {R}_{\{ SAL \}} ( x , y ) , 0 \leq λ \leq 1 \qquad ( Equation \#1 )$$

where λ can be a hyperparameter that can be tuned, or can be fixed apriori

In Equation #1 shown above, the R_{{LLM}}(x, z) term represents the combined score, the R (x, y) represents the ROUGE score term, and the R_{{SAL}}(x, y) term represents the ROUGE-SAL score. R(x, y) denotes the ROUGE score between the reference summary (e.g., 516) given the input x (e.g., 512) and the generated summary y (e.g., 570). ROUGE scores are used as a metric for the quality of a summary that may be generated using automated techniques, such as using ML-based techniques. It is computed by comparing an automatically generated summary against one or more reference summaries, which are typically produced by a human. For the embodiment depicted in FIG. 5, the ROUGE score is computed by comparing summary 570 generated by BB-LLM 530 for content to be summarized in a training datapoint to reference summary 516 included in that training datapoint. In certain implementations, a ROUGE score has a value that ranges between 0 and 1, with higher scores indicating a higher similarity between the automatically generated summary and the reference summary.

A regular ROUGE metric gives equal weightage to each of the tokens (e.g., words) in the automatically generated summary and the reference summary. As a result, a ROUGE score by itself is not sufficient for evaluating the quality of an entity-aware summary where more weightage is to be given to tokens or words (or entities) that correspond to the one or more entity categories identified in the training datapoint. A new score is thus needed to evaluate the quality of such entity-aware summaries. This is accomplished by using a new and novel ROUGE-SAL (R_{{SAL}}(x, y)) score that gives more weightage to the extracted entities from the content to be summarized that correspond to the one or more entity categories. In certain implementations, the combined score (R_{{LLM}}(x, z)) is formulated as the convex combination of the ROUGE score and the new ROUGE-SAL score and by adding a tunable hyperparameter λ. The combined score metric assigns a fraction (λ) of the score equally to all the tokens in the summary (i.e., to the ROUGE score), and an additional (remaining) fraction (1−λ) of score to important, salient words/phrases corresponding to entity categories in the computation of ROUGE-SAL score, while computing the combined score. The combined score, R_{{LLM}}(x, z), may be referred to as a reward. In some embodiments, additional calculations may be used to determine a reward based on the combined score.

For ROUGE-SAL metric related to weightage, suppose there are l entities corresponding to entity categories (appearing in a collection E) in the BB-LLM 530 generated entity-aware summary (e.g., 570). These entities can be represented using tokens. For this, assume a collection Γ of tokens appearing in these entities as, Γ, and the rest of the tokens appear in the set as Δ. It is further assumed that BB-LLM 530 can produce a saliency score for a token α as γ(α) which is the probability (can be a conditional probability depending on the appearance of other tokens) of the token w appearing in the generated summary as output from BB-LLM. However, if the token b appears in Γ, then the token is upweighted and assigned a saliency score

$$δ ( b ) = k * γ ( b ) , \qquad ( Equation \#2 )$$

where k can be taken as 1.5, and γ(b) is the output probability of token b as generated by the BB-LLM as before.

In the embodiment depicted in FIG. 5, the combined score is computed by the combined score calculator 540. The computed score 542 is then provided to update generator 590 for updating parameters of PLM 520 using one or more RL techniques. The update generator 590 may compute an updated reward (r(x, z)) based on the combined score. The updated reward is then used to update the model parameters of the PLM 520.

$$r ( x , z ) = {R}_{\{ LLM \}} ( x , z ) - β log \frac{\{ π ( z \vert x ) \}}{\{ {p}_{\{ PLM \}} ( z \vert x ) \}} \qquad ( Equation \#3 )$$

$${R}_{\{ LLM \}} ( x , z ) = R ( x , y ) , y ∼ {p}_{\{ LLM \}} ( \cdot \vert x , z ) \qquad ( Equation \#4 )$$

As shown above in Equation #3, a KL-divergence penalty reward (r(x, z)) is added to keep the policy network π from moving too far from the initial policy LM p_{{PLM}}. In Equation #3, r(x, z) is the final reward. R_{{LLM}}(x, z) is the reward for the LLM for generating stimulus z (e.g., 552) given the input text x (e.g., 512). β is a coefficient that needs to be tuned during training.

$$log \frac{\{ π ( z \vert x ) \}}{\{ {p}_{\{ PLM \}} ( z \vert x ) \}}$$

is KL-divergence term.

In equation #4, R(x, y) may be the ROUGE score of the generated summary y with respect to the given summary (or reference summary) given the input text x (e.g., 512). y may be the generated output summary (e.g., 570) by the LLM (e.g., 530) given the generated stimulus z (e.g., hint 522) and the original input x. For the summarization task, the input x may be an article, and the output y may be the corresponding summary output by the LLM. To incorporate entity type information (e.g., 514), some entities (e.g., n-grams or key phrases) can be used as stimulus z (e.g., hint 522) that guides the LLM to generate better summaries. Thus, policy LLM, P_{{LLM}}(⋅|x, z), that can generate such stimulus for each input text x may be used. As a result, the combined score, R_{{LLM}}(x, z), can be equal to the ROUGE score, R(x, y).

Supervised fine-tuning canoe may be used to model the policy LM (PLM). However, sometimes, it cannot be guaranteed that the heuristically selected pseudo-stimulus is optimal and the supervised fine-tuned PLM could generate the stimulus that leads to the desired BB-LLM output summary. Thus, using RL to further fine-tune the PLM can directly optimize the BB-LLM's output.

The following is an example or illustration of ROUGE-SAL score computation:
Content to be summarized (e.g., 512): “Paris is the capital of France. It has the maximum population among all cities in France with an estimated 2,175,601 people living is the city which covers an area of more than 105 sq kilometers. The city of Paris is the center and seat of Government in the region and province of Ile-de-France or Paris region.”
Entity categories (e.g., 514) (which may be provided by an end user of the SS): (1) City, (2) Country, (3) State
Extracted entities by PLM 520 (or hint, e.g., 522): Paris (for category City), France (for category Country), Ile-de-France (for category State)
Reference Summary (e.g., 516): Paris (City) is the capital and most populous city of France (Country).
Entity-aware summary (e.g., 570) generated by BB-LLM 530: Paris is the capital of France having the maximum population. It is the seat of the province Ile-de-France (State).
Longest common subsequences: ‘Paris is the capital’
Tokens: Paris, is, the capi, tal etc.

$${\sum }_{\{ i = 1 \}}^{u} {LCS}_{⋃}^{*} ( {r}_{i} , G ) ) = β ( Paris ) + γ ( is ) + γ ( the ) + γ ( capital ) ( = num )$$

$$β ( Paris ) = P ( Paris ) , γ ( is ) = P ( is ) , γ ( the ) = P ( the ) , γ ( capital ) = P ( capi ) * P ( tal )$$

Suppose tokens in the BB-LLM-generated summary are: Paris, is, the capi, tal, of France, hav, ing, the maxi, mum, popu, lation, it, is, the, seat, of the reg, ion, Ile, de, France, or Pari, reg, ion.

It is possible to have probability score for each of these tokens from the BB-LLM output. Hence the denominator of the precision will the sum of the probability scores of these tokens, that is

$$γ ( Paris ) + γ ( is ) + γ ( the ) + γ ( capital ) + γ ( of ) + γ ( France ) + … ( = deno - Precision , say ) .$$

Finally, the unigrams appearing in the reference summary is: Paris, is, the, capital, and, most, populous, city, of, France. The transition probability of the words in the reference summary and the denominator in the expression for recall can be computed, that is, ζ(Paris)+ζ(is)+ζ(the)+ζ(capital)+ . . . (=deno-Recall, say). Now the techniques can compute all ROUGE-SAL metrics:

$${P}_{lcs}^{s} , {R}_{lcs}^{s} , {F}_{lcs}^{s}$$

etc. Here,

$${P}_{lcs}^{s}$$

is the precision of the longest subsequences in the generated summary with respect to the longest subsequences in the reference summary.

$${R}_{lcs}^{s}$$

is the recall for the same.

$${F}_{lcs}^{s}$$

is the ROUGE-SAL score.

The RL training subsystem 504 then updates the PLM 520. For example, in embodiments where PLM 520 is a type of neural network, updating the parameters of the PLM can include changing the weights associated with the nodes in the neural network.

As described above, SFT (in FIG. 4) and RL (in FIG. 5) training techniques may be used to train PLM 530. In some embodiments, both techniques may be used. Once sufficiently trained, the PLM 530 can then be used by the SS for runtime generation of summaries.

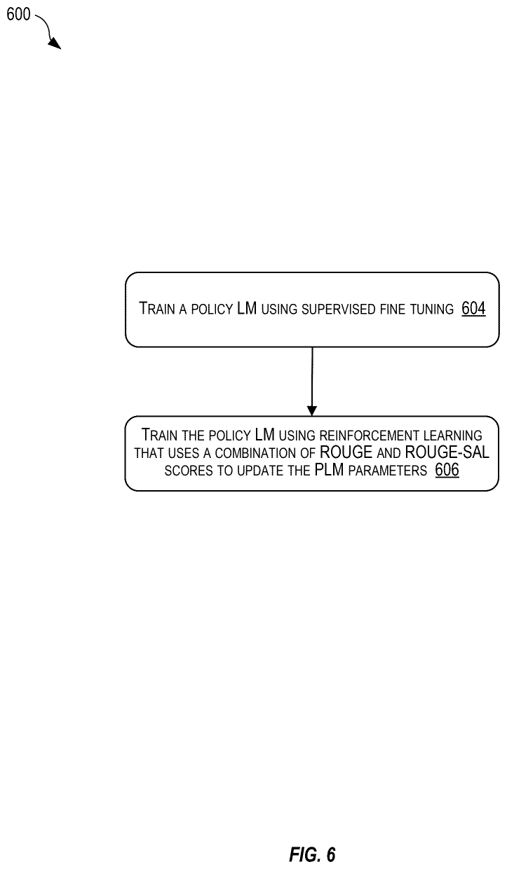

FIG. 6 is an example flowchart illustrating a generalized method for training a summarization system (SS), according to certain embodiments. The processing depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 6 may include a greater number or a lesser number of steps than those depicted in FIG. 6.

At 604, a policy LM (PLM) is trained using supervised fine-tuning techniques. For example, in FIG. 4, the PLM (e.g., a BERT model) 420 may be trained using supervised fine-tuning (SFT) techniques 480 to perform entity extraction based on entity categories provided by a client.

At 606, the PLM is also trained using reinforcement learning that uses a combination of ROUGE and ROUGE-SAL scores to update the PLM parameters. For example, in FIG. 5, the PLM 520 may be trained via an RL training sub-system 504 that also directly optimize the BB-LLM generated summary (i.e., entity-aware summary 570). In some embodiments, the SFT (in FIG. 4) and RL (in FIG. 5) techniques may be performed concurrently to train the PLM.

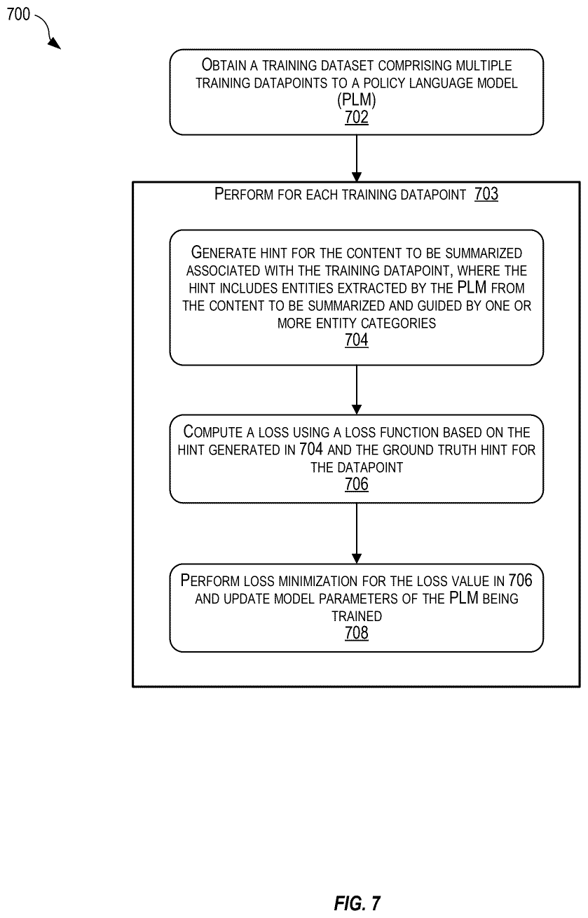

FIG. 7 is an example flowchart illustrating a method (e.g., SFT) for training a policy language model (PLM) within the SS, according to certain embodiments. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 7 may include a greater number or a lesser number of steps than those depicted in FIG. 7.

At 702, a training dataset comprising multiple training datapoints to a policy language model (PLM) may be obtained. For example, in FIG. 4, a training dataset 410 comprising multiple training datapoints, where each training datapoint 411 may include content to be summarized 412, entity categories 414, and ground truth hint 416.

At 703, steps 704, 706, and 708 are performed for each training datapoint. At 704, a hint for the content to be summarized associated with the training datapoint may be generated, where the hint includes entities extracted by the PLM from the content to be summarized and guided by one or more entity categories. For example, in FIG. 4, the content to be summarized 412 and entity categories 414 are provided as input to the PLM 420 to generate hint 430. The hint may include the entities corresponding to the entity categories 414 and extracted from the content to be summarized 412.

At 706, a loss may be computed using a loss function based on the hint generated in 704 and the ground truth hint for the datapoint. For example, in FIG. 4, a loss function, as part of the loss calculation and the loss minimization sub-system 450, may compute a loss based on the discrepancy between the model's prediction (e.g., the generated hint 430) and the ground truth hint 416 for a datapoint 411.

At 708, a loss minimization may be performed for the loss value in 706 and update model parameters of the PLM being trained. For example, in FIG. 4, by using backward propagation techniques, the loss calculation and the loss minimization sub-system 450 may further perform loss minimization by updating the PLM's parameters (e.g., weights and biases) 484 to minimize the computed loss.

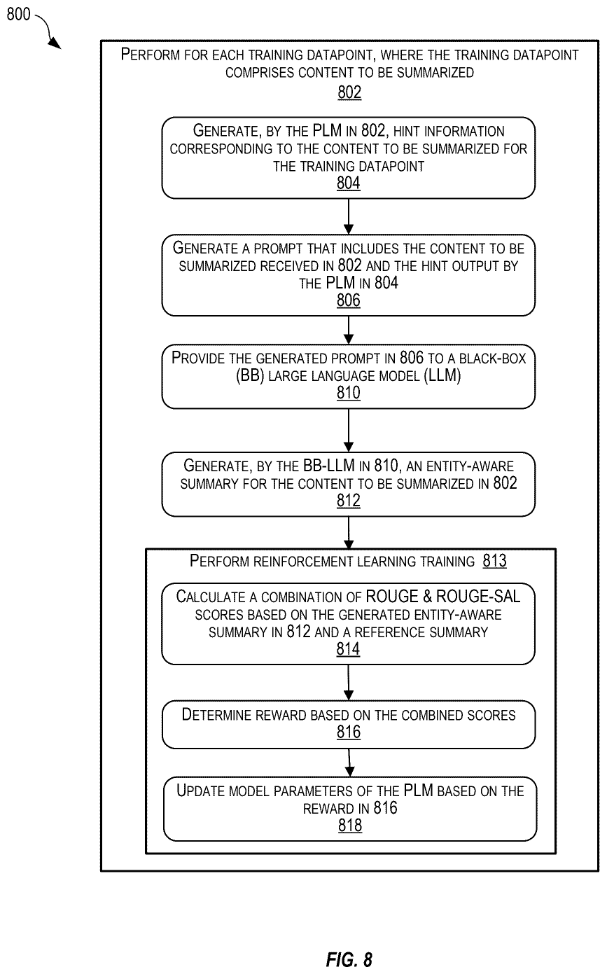

FIG. 8 is an example flowchart illustrating a method (e.g., RL) for training a policy language model (PLM) within the SS, according to certain embodiments. The processing depicted in FIG. 8 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 8 may include a greater number or a lesser number of steps than those depicted in FIG. 8.

In FIG. 8, at 802, all sub-steps (804 to 816) are performed for each of the training datapoints in a training dataset (e.g., 510 of FIG. 5). A training datapoint may include content to be summarized 512, entity categories 514, and reference summary 516.

At 804, a PLM may generate hint information corresponding to the content to be summarized for the training datapoint. For example, in FIG. 5, the PLM 520 may receive content to be summarized 512 and entity categories 514 as inputs, and generate a hint 522 corresponding to the content to be summarized 512 in the training datapoint 511.

At 806, a prompt that includes the content to be summarized received in 802 and the hint output by the PLM in 804 may be generated. For example, in FIG. 5, a prompt generator 524 may generate a prompt 526 that includes the hint 522 and the content to be summarized 512.

At 810, the generated prompt in 806 may be provided to a black-box (BB) large language model (LLM). For example, in FIG. 5, the prompt 526 may be provided as input to the BB-LLM 530.

At 812, the BB-LLM in 810 may generate an entity-aware summary for the content to be summarized in 802. For example, in FIG. 5, in response to the prompt 526, the BB-LLM 530 may generate an entity-aware summary 570.

Step 813, which includes sub-steps 814 to 816, may perform reinforcement learning training. At 814, a combination of ROUGE & ROUGE-SAL scores are calculated based on the generated entity-aware summary in 812 and a reference summary. For example, in FIG. 5, the RL training sub-system 504 may calculate a combined score (R_{{LLM}}(x, z)) 542 that is formulated as the convex combination of the ROUGE score and ROUGE-SAL score based on generated entity-aware summary 570 and the ground truth summary (i.e., reference summary) 516 for the training datapoint 511.

At 816, a reward may be determined based on the combined score. For example, in FIG. 5, a reward (r(x, z)) may be calculated based on the combined score (R_{{LLM}}(x, z)), which is a convex combination of the ROUGE score and ROUGE-SAL score. In some embodiments, the combined score may be used as the reward, and the update generator 590 further generates an updated reward.

At 818, model parameters of the PLM may be updated based on the reward (or updated reward) in 816. For example, in FIG. 5, the model parameters of the PLM 520 may be updated based on the reward generated by the RL training sub-system 504. As a result, reinforcement learning (RL) techniques may be used for training the PLM 520 while directly optimizing the BB-LLM generated summary 570.

### Example Cloud Service Provider Infrastructure (CSPI) Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users,' or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

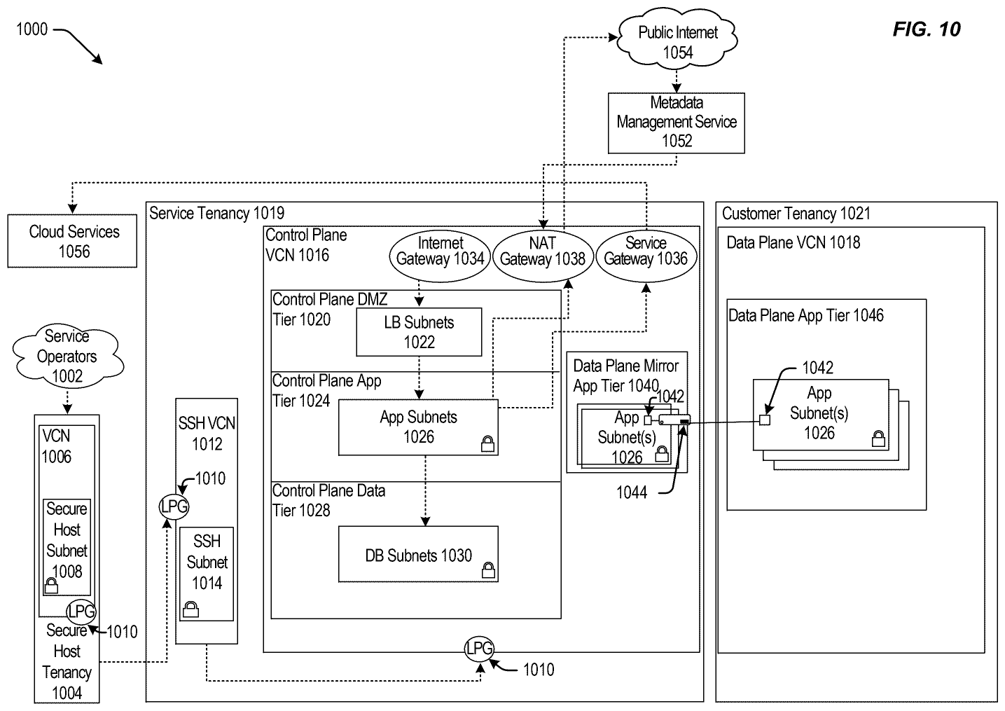

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

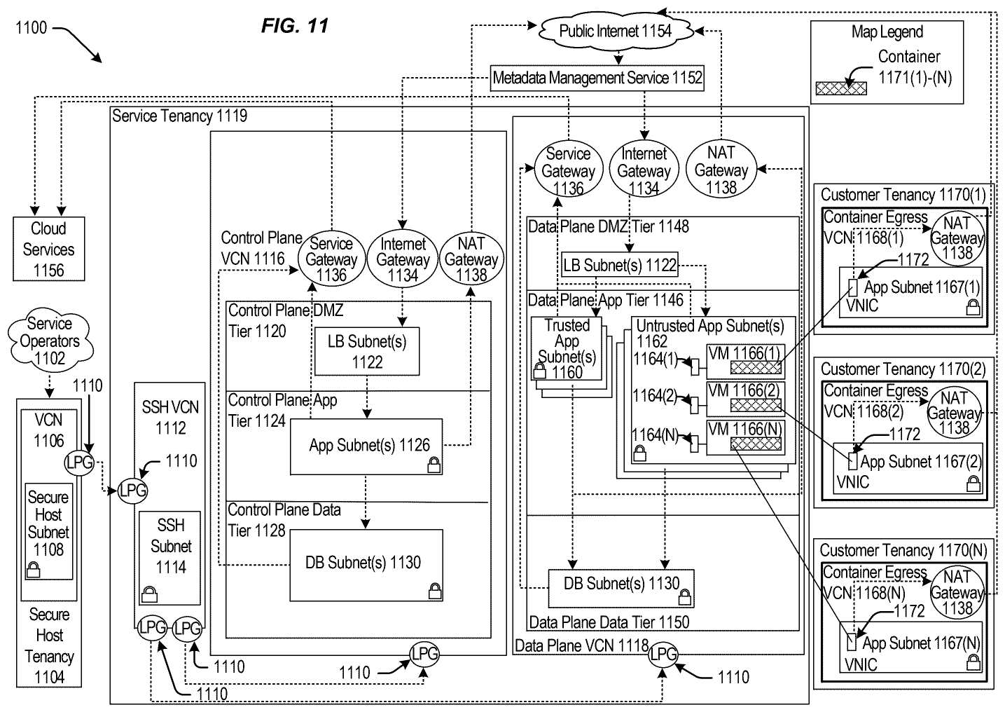

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

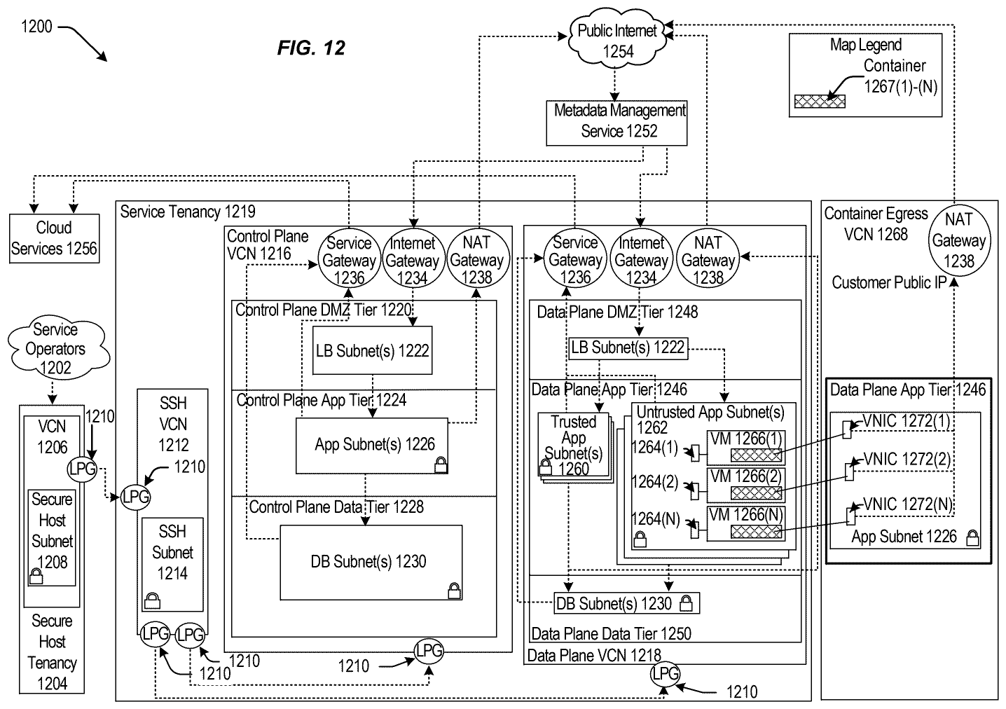

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a summarization system (SS) comprising one or more computer systems, content to be summarized;
generating, by the SS, a hint based upon the content to be summarized, the hint comprising one or more entities identified by the SS from the content to be summarized, the one or more entities corresponding to one or more entity categories, wherein each entity in the one or more entities is a word occurring in the content to be summarized or a sequence of adjacent words occurring in the content to be summarized;
generating, by the SS, a prompt comprising the content to be summarized and the hint;
providing, by the SS, the prompt as input to a large language model (LLM); and
responsive to the prompt, generating, by the LLM, a summary for the content to be summarized.

2. The method of claim 1, wherein the summary generated for the content to be summarized comprises one or more entities, wherein each entity in the one or more entities is extracted from the content to be summarized, corresponds to an entity category of the one or more entity categories, and occurs at least once in the summary.

3. The method of claim 1, wherein generating the hint comprises extracting, by the SS, the one or more entities using a particular machine learning model.

4. The method of claim 3, wherein the particular machine learning model is a second large language model.

5. The method of claim 4, further comprising training the second large language model using a contextual prompting technique; wherein using the contextual prompting technique comprises:
providing one or more examples to the second large language model, wherein each of the one or more examples comprises an entity, a corresponding entity category, and content to be summarized.

6. The method of claim 3, wherein the particular machine learning model is a model configured to perform entity extraction.

7. The method of claim 3, further comprising training the particular machine learning model using a supervised fine-tuning technique and a plurality of training datapoints, each training datapoint in the plurality of training datapoints comprising training content to be summarized, a training entity category, and a ground truth hint comprising at least one entity identified in the training content to be summarized and corresponding to the training entity category associated with the training datapoint.

8. The method of claim 7, wherein using the supervised fine-tuning technique further comprises, for at least a first training datapoint in the plurality of training datapoints:
computing a loss based on the hint generated by the particular machine learning model and the ground truth hint associated with the first training datapoint; and
minimizing the loss using a loss minimization technique, wherein the minimizing comprises updating the particular machine learning model.

9. The method of claim 3, further comprising training the particular machine learning model using a reinforcement learning technique and a plurality of training datapoints, each training datapoint in the plurality of training datapoints comprising training content to be summarized, a training entity category, and a reference summary for the training content to be summarized, wherein the reference summary comprises at least one entity identified in the training content to be summarized that corresponds to the training entity category in the training datapoint.

10. The method of claim 9, wherein using the reinforcement learning technique comprises, for at least a first training datapoint in the plurality of training datapoints:
providing the first training datapoint as input to the particular machine learning model;
generating, by the particular machine learning model, a training prompt comprising the training content to be summarized and a hint based on the training content to be summarized;
providing the training prompt to the LLM;
generating, by the LLM and responsive to the training prompt, a first predicted summary; and
updating the particular machine learning model based upon the first predicted summary and the reference summary.

11. The method of claim 10, wherein updating the particular machine learning model comprises:
calculating a combination of a first score and a second score based on the first predicted summary generated by the LLM and the reference summary, wherein the first score and the second score are generated by comparing the first predicted summary and the reference summary;
determining a reward based on the combination of the first score and the second score; and
updating the particular machine learning model based on the determined reward.

12. The method of claim 11, wherein the first score provides equal weightage to each token in the training content to be summarized associated with the first training datapoint, and the second score provides more weightage to the entity extracted from the training content to be summarized associated with the first training datapoint and corresponding to the training entity category in the first training datapoint.

13. The method of claim 3, further comprising training the particular machine learning model using a supervised fine-tuning technique and a reinforcement learning technique concurrently.

14. A non-transitory computer-readable medium storing computer-executable instructions that, when executed by one or more processors of a computing system, cause the one or more processors to perform operations comprising:
receiving, by a summarization system (SS) comprising one or more computer systems, content to be summarized;
generating, by the SS, a hint based upon the content to be summarized, the hint comprising one or more entities identified by the SS from the content to be summarized, the one or more entities corresponding to one or more entity categories, wherein each entity in the one or more entities is a word occurring in the content to be summarized or a sequence of adjacent words occurring in the content to be summarized;
generating, by the SS, a prompt comprising the content to be summarized and the hint;
providing, by the SS, the prompt as input to a large language model (LLM); and
responsive to the prompt, generating, by the LLM, a summary for the content to be summarized;
wherein the summary for the content to be summarized comprises one or more entities, wherein each entity in the one or more entities is extracted from the content to be summarized, corresponds to an entity category of the one or more entity categories, and occurs at least once in the summary; and
wherein generating the hint comprises extracting the one or more entities using a particular machine learning model in the SS.

15. The non-transitory computer-readable medium of claim 14, wherein the particular machine learning model is a second large language model or a model configured to perform entity extraction.

16. The non-transitory computer-readable medium of claim 14, further comprising training the particular machine learning model using a supervised fine-tuning technique and a plurality of training datapoints, each training datapoint in the plurality of training datapoints comprising training content to be summarized, a training entity category, and a ground truth hint comprising at least one entity identified in the training content to be summarized and corresponding to the training entity category associated with the training datapoint;
wherein using the supervised fine-tuning technique further comprises, for at least a first training datapoint in the plurality of training datapoints:
computing a loss based on the hint generated by the particular machine learning model and the ground truth hint associated with the first training datapoint; and
minimizing the loss using a loss minimization technique, wherein the minimizing comprises updating the particular machine learning model.

17. The non-transitory computer-readable medium of claim 14, further comprising training the particular machine learning model using a reinforcement learning technique and a plurality of training datapoints, each training datapoint in the plurality of training datapoints comprising training content to be summarized, a training entity category, and a reference summary for the training content to be summarized, wherein the reference summary comprises at least one entity identified in the training content to be summarized that corresponds to the training entity category in the training datapoint;
wherein using the reinforcement learning technique comprises, for at least a first training datapoint in the plurality of training datapoints:
providing the first training datapoint as input to the particular machine learning model;
generating, by the particular machine learning model, a training prompt comprising the training content to be summarized and a hint based on the training content to be summarized;
providing the training prompt to the LLM;
generating, by the LLM and responsive to the training prompt, a first predicted summary; and
updating the particular machine learning model based upon the first predicted summary and the reference summary.

18. A computing system, comprising:
one or more processors; and
one or more non-transitory computer readable media storing computer-executable instructions that, when executed by the one or more processors of the computing system, cause the computing system to perform operations comprising:
receiving, by a summarization system (SS) comprising one or more computer systems, content to be summarized;
generating, by the SS, a hint based upon the content to be summarized, the hint comprising one or more entities identified by the SS from the content to be summarized, the one or more entities corresponding to one or more entity categories, wherein each entity in the one or more entities is a word occurring in the content to be summarized or a sequence of adjacent words occurring in the content to be summarized;
generating, by the SS, a prompt comprising the content to be summarized and the hint;
providing, by the SS, the prompt as input to a large language model (LLM); and
responsive to the prompt, generating, by the LLM, a summary for the content to be summarized;
wherein the summary for the content to be summarized comprises one or more entities, wherein each entity in the one or more entities is extracted from the content to be summarized, corresponds to an entity category of the one or more entity categories, and occurs at least once in the summary; and
wherein generating the hint comprises extracting the one or more entities using a particular machine learning model in the SS.

19. The system of claim 18, further comprising training the particular machine learning model using a supervised fine-tuning technique and a plurality of training datapoints, each training datapoint in the plurality of training datapoints comprising training content to be summarized, a training entity category, and a ground truth hint comprising at least one entity identified in the training content to be summarized and corresponding to the training entity category associated with the training datapoint;
wherein using the supervised fine-tuning technique further comprises, for at least a first training datapoint in the plurality of training datapoints:
computing a loss based on the hint generated by the particular machine learning model and the ground truth hint associated with the first training datapoint; and
minimizing the loss using a loss minimization technique, wherein the minimizing comprises updating the particular machine learning model.

20. The system of claim 18, further comprising training the particular machine learning model using a reinforcement learning technique and a plurality of training datapoints, each training datapoint in the plurality of training datapoints comprising training content to be summarized, a training entity category, and a reference summary for the training content to be summarized, wherein the reference summary comprises at least one entity identified in the training content to be summarized that corresponds to the training entity category in the training datapoint;
wherein using the reinforcement learning technique comprises, for at least a first training datapoint in the plurality of training datapoints:
providing the first training datapoint as input to the particular machine learning model;
generating, by the particular machine learning model, a training prompt comprising the training content to be summarized and a hint based on the training content to be summarized;
providing the training prompt to the LLM;
generating, by the LLM and responsive to the training prompt, a first predicted summary; and
updating the particular machine learning model based upon the first predicted summary and the reference summary.
